(19) United States
(12) Patent Application Publication
(10) Pub. No.: US 2014/0022199 A1
(43) Pub. Date: Jan. 23, 2014

(54) CAPACITIVE TOUCH PANEL HAVING IMPROVED RESPONSE CHARACTERISTICS

(71) Applicants: Tao Peng, Nashua, NH (US); Nathan Y. Moyal, Mukilteo, WA (US); Jackson Ai, Shanghai (CN)

(72) Inventors: Tao Peng, Nashua, NH (US); Nathan Y. Moyal, Mukilteo, WA (US); Jackson Ai, Shanghai (CN)

(73) Assignee: TEXAS INSTRUMENTS INCORPORATED, Dallas, TX (US)

(21) Appl. No.: 13/553,644

(22) Filed: Jul. 19, 2012

(51) Int. Cl. G06F 3/044

(52) U.S. Cl. 345/174

(57) ABSTRACT

An apparatus is provided. A substrate and a cover plate are provided. A sensor layer is formed on at least one of the substrate and the cover plate. The sensor layer includes a plurality of row electrodes and a plurality of column electrodes interleaved with the plurality of row electrodes, where each row electrode and each column electrode is formed of a plurality of stair-stepped diamonds. An insulator is also included so as to electrically isolate the plurality of row electrodes and the plurality of column electrodes, where the insulator is substantially transparent to visible spectrum light. A bridge layer is also formed over the sensor layer and having a plurality of bridges, where each bridge is coupled between two adjacent stair-stepped diamonds from at least one of the column electrodes or the row electrodes.

### TECHNICAL FIELD

The invention relates generally to a touch panel and, more particularly, to a capacitive touch panel having an improved response.

### BACKGROUND

Turning to FIGS. 1 and 2, an example of a conventional system 100 can be seen. System 100 generally comprises a touch panel 102 and touch panel controller 104. The touch panel 102 has an array of sensors formed by a set of column electrodes (e.g., electrode 103), where each electrode of each column is coupled together by a strip electrode (e.g., strip electrode 107), and a set of row electrodes (e.g., electrode 105), where each electrode of each row is coupled together by a strip electrode (e.g., strip electrode 109). Usually, the column and row electrodes (e.g., electrodes 103 and 105) are formed in two separate layers with a dielectric or insulating layer formed therebetween, and these conductive layers which form the electrodes (e.g., electrodes 105 and 109) are generally transparent to visible spectrum light (e.g., light having a wavelength from about 380 nm to about 750 nm). The strip electrodes for each column (e.g., strip electrode 107) are then coupled to the interface or I/F 106 of the touch panel controller 104 by terminals X-1 to X-N, while the strip electrodes for each row (e.g., strip electrode 109) are coupled to the interface 106 by terminals Y-1 to Y-M. The interface 106 is able to communicate with the control circuit 108. As shown in greater detail in FIG. 2, the interface 106 is generally comprised of a multiplexer or mux 202 and an exciter 204.

In operation, the interface 106 (which is usually controlled by the control circuit 108) selects and excites columns of electrodes (e.g., electrode 103) and “scans through” the rows of row electrodes (e.g., electrode 105) so that a touch position from a touch event can be resolved. As an example, interface 204 can excite two adjacent columns through terminals X-j and X-(j+1) with excitation signals EXCITE[j] and EXCITE[j+1], and interface 106 receives a measurement signal from a row associated with terminal Y-i. When an object (e.g., finger) is in proximity to the touch panel (which is generally considered to be a touch event), there is a change in capacitance due at least in part to the arrangement of electrodes (e.g., electrodes 103 and 105), and the controller 108 is able to resolve the position of the touch event.

Most conventional touch panels (e.g., touch panel 102) can become less sensitive, depending on its environment. For low ground impendence (e.g., device being held in the hand), sensitivity of the touch panels (e.g., touch panel 102) is based on self-capacitance between the sensor electrodes and “human ground” and mutual capacitance between the electrodes. However, for high ground impedances (e.g., device set on a table), the self-capacitance (i.e., with “human ground”) will contribute a negative signal, which can decrease sensitivity by as much as two times. Therefore, there is a need for a touch panel that has better sensitivity, irrespective of its environment.

Some examples of other conventional systems are: U.S. Pat. No. 6,188,391; U.S. Patent Pre-Grant Publ. No. 2006/0097991; U.S. Patent Pre-Grant Publ. No. 2009/0091551; U.S. Patent Pre-Grant Publ. No. 2010/0149108; U.S. Patent Pre-Grant Publ. No. 2010/0156810; U.S. Patent Pre-Grant Publ. No. 2010/0321326; U.S. Patent Pre-Grant Publ. No. 2011/0095996; U.S. Patent Pre-Grant Publ. No. 2011/0095997; U.S. Patent Pre-Grant Publ. No. 2011/0102361; U.S. Patent Pre-Grant Publ. No. 2011/0157079; U.S. Patent Pre-Grant Publ. No. 2012/0056664; PCT Publ. No. WO2009046363; and PCT Publ. No. WO2011018594.

### SUMMARY

An embodiment of the present invention, accordingly, provides an apparatus. An apparatus comprises a substrate; a cover plate that is substantially transparent to visible spectrum light; a sensor layer formed on at least one of the substrates and the cover plate, wherein the sensor layer includes: a plurality of row electrodes; a plurality of column electrodes interleaved with the plurality of row electrodes, wherein each row electrode and each column electrode is formed of a plurality of stair-stepped diamonds; and an insulator that electrically isolates the plurality of row electrodes and the plurality of column electrodes, wherein the insulator is substantially transparent to visible spectrum light; and a bridge layer formed over the sensor layer and having a plurality of bridges, wherein each bridge is coupled between two adjacent stair-stepped diamonds from at least one of the column electrodes or the row electrodes.

In accordance with the present invention, the conductive layer is formed on the cover plate.

In accordance with the present invention, the conductive layer is formed on the substrate.

In accordance with the present invention, the plurality of bridges further comprises a plurality of set of bridges, wherein each set of bridges is associated with at least one of the column electrodes.

In accordance with the present invention, the plurality of bridges further comprises a plurality of set of bridges, wherein each set of bridges is associated with at least one of the row electrodes.

In accordance with the present invention, each stair-stepped diamond is formed of a conductive trace.

In accordance with the present invention, each bridge and each conductive trace is substantially transparent to visible spectrum light.

In accordance with the present invention, the sensor layer further comprises a plurality of floating regions, wherein each floating region is substantially transparent to visible spectrum light, and wherein each floating region is located within at least one of the stair-stepped diamonds.

In accordance with the present invention, each bridge is substantially transparent to visible spectrum light, and wherein each stair-stepped diamond is formed of a conductive pad.

In accordance with the present invention, an apparatus is provided. The apparatus comprises a touch panel having: a substrate; a cover plate that is substantially transparent to visible spectrum light; a sensor layer formed on at least one of the substrate and the cover plate, wherein the sensor layer includes: a plurality of row electrodes; a plurality of column electrodes interleaved with the plurality of row electrodes, wherein each row electrode and each column electrode is formed of a plurality of stair-stepped diamonds; and an insulator that electrically isolates the plurality of row electrodes and the plurality of column electrodes, wherein the insulator is substantially transparent to visible spectrum light; and a bridge layer formed over the sensor layer and having a plurality of bridges, wherein each bridge is coupled between two adjacent stair-stepped diamonds from at least one of the column electrodes or the row electrodes; an interconnect that is coupled to each row electrode and each column electrode; and a touch panel controller that is coupled to the interconnect.

In accordance with the present invention, an apparatus is provided. The apparatus comprises a touch panel having: a display; a substrate that is secured to the display, wherein the substrate is substantially transparent to visible spectrum light; a sensor layer formed over the substrate, wherein the sensor layer includes: a plurality of row electrodes formed over the substrate, wherein each row electrode is formed of a first set of stair-stepped diamonds; a plurality of column electrodes formed over the substrate, wherein each column electrode is formed of a second set of stair-stepped diamonds that are coupled together; and an first insulator that is formed over the substrate, wherein the first insulator is substantially transparent to visible spectrum light, and wherein the first insulator electrically isolates the plurality of row electrodes and the plurality of column electrodes; a bridge layer formed over the sensor layer, wherein the bridge layer includes: a plurality of sets of bridge conductors, wherein each set of bridge conductors is associated with at least one of the row electrodes so as to couple each stair-stepped diamond in each row electrode together; and a second insulator formed over the sensor layer, wherein the second insulator is substantially transparent to visible spectrum light; a cover plate that is secured to the bridge layer, wherein the cover plate is substantially transparent to visible spectrum light; an interconnect that is coupled to each column electrode and each row electrode; and a touch panel controller having: an interface that is coupled to the interconnect; and a control circuit that is coupled to the interface.

In accordance with the present invention, the sensor layer further comprises a plurality of floating regions, wherein each floating region is located within at least one of the stair-stepped diamonds.

In accordance with the present invention, the plurality of row electrodes, the plurality of column electrodes, and the plurality of bridge conductors are formed of indium tin oxide (ITO).

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1 and 2 are diagrams of an example of a conventional system;

FIG. 3 is diagrams of an example of a system in accordance with the present invention;

FIGS. 4 and 5 are examples of a portion of the touch panel of FIG. 3;

FIG. 6 is a cross-sectional view of the bridges in the portion of the touch panel of FIGS. 4 and 5 along section line I-I; and

FIGS. 7-9 depict alternative examples of the stair-stepped diamond patterns shown in FIGS. 4 and 5.

### DETAILED DESCRIPTION

Refer now to the drawings wherein depicted elements are, for the sake of clarity, not necessarily shown to scale and wherein like or similar elements are designated by the same reference numeral through the several views.

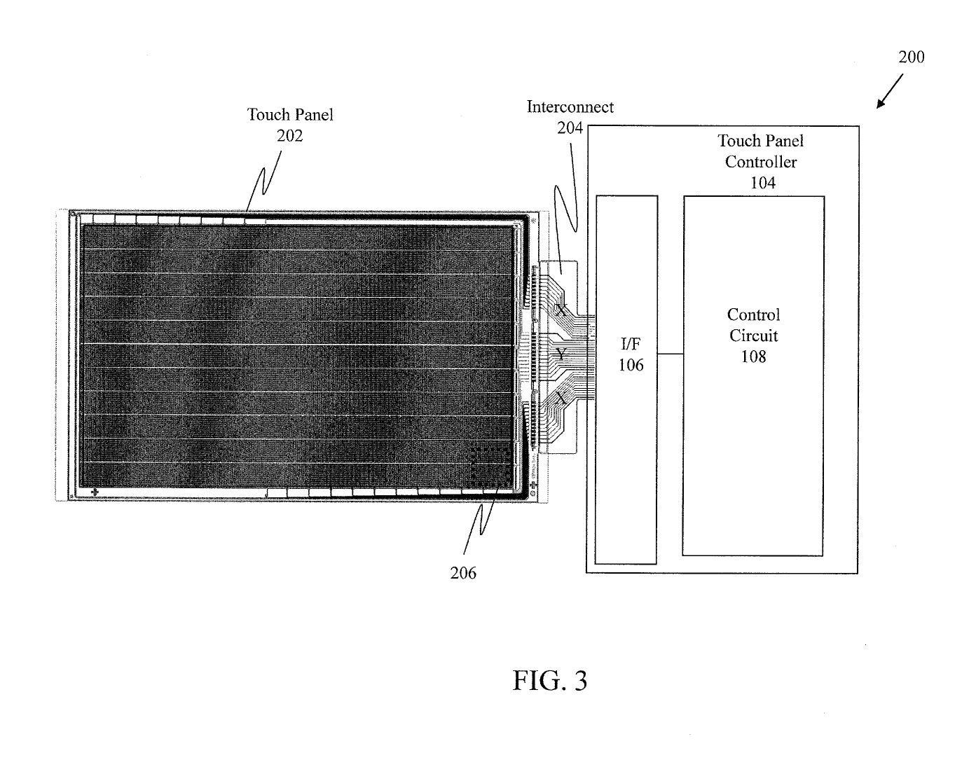

Turning to FIG. 3, an example of a system 200 in accordance with the present invention can be seen. System 200 is similar in construction to system 100 except that touch panel 102 has been replaced by touch panel 202. Additionally, interconnect 204 has been provided to provide communication channels between the touch panel controller 104 and the touch panel 202.

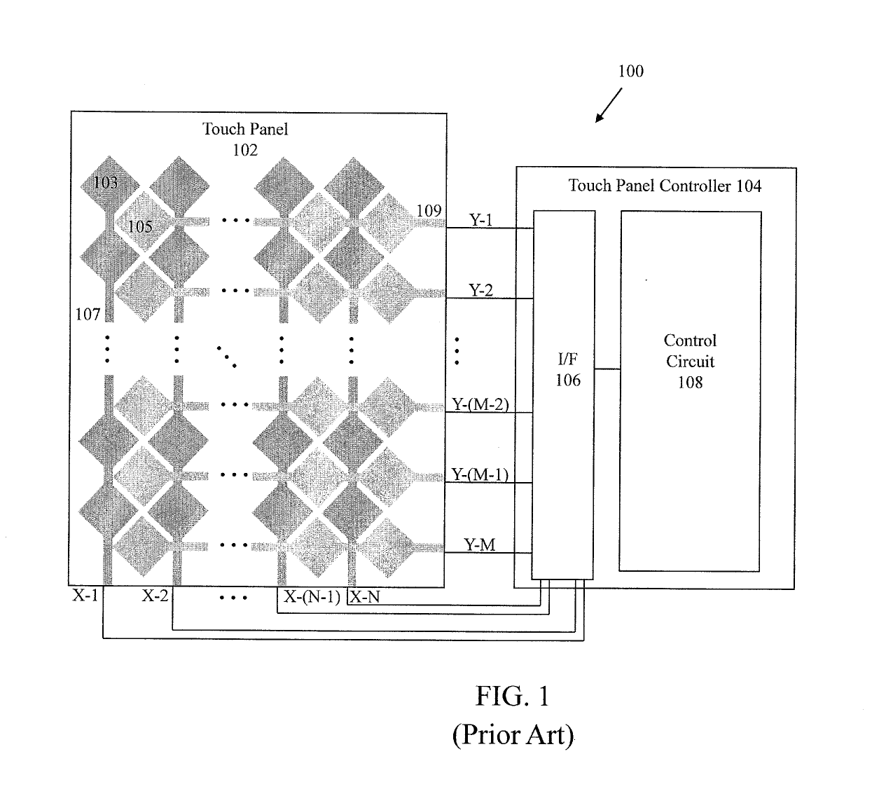

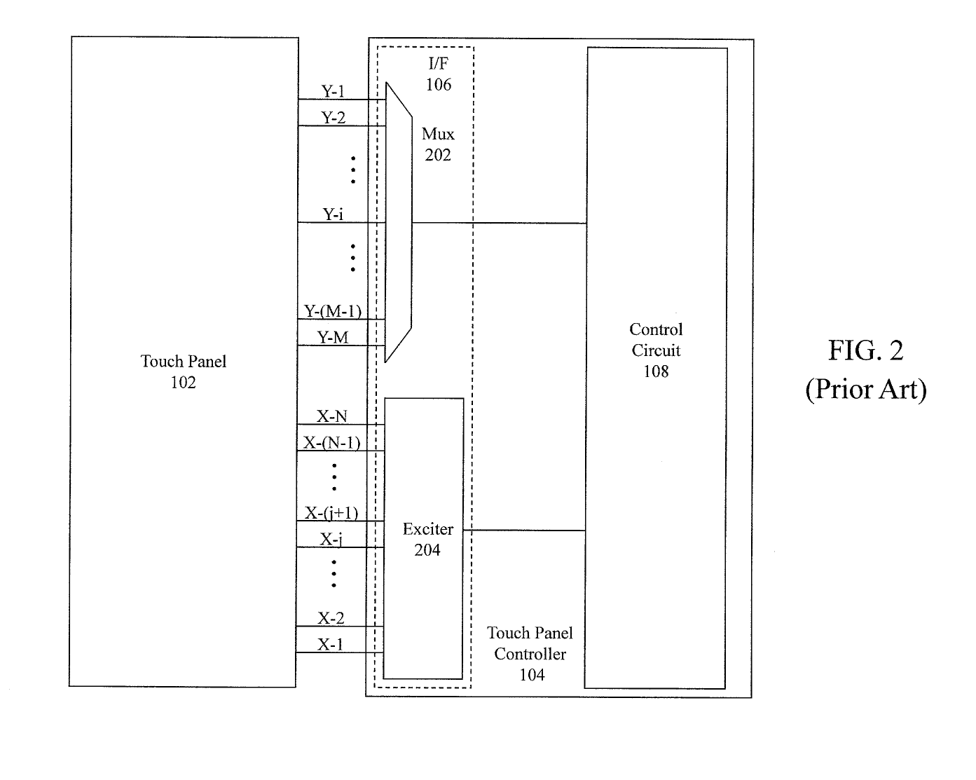

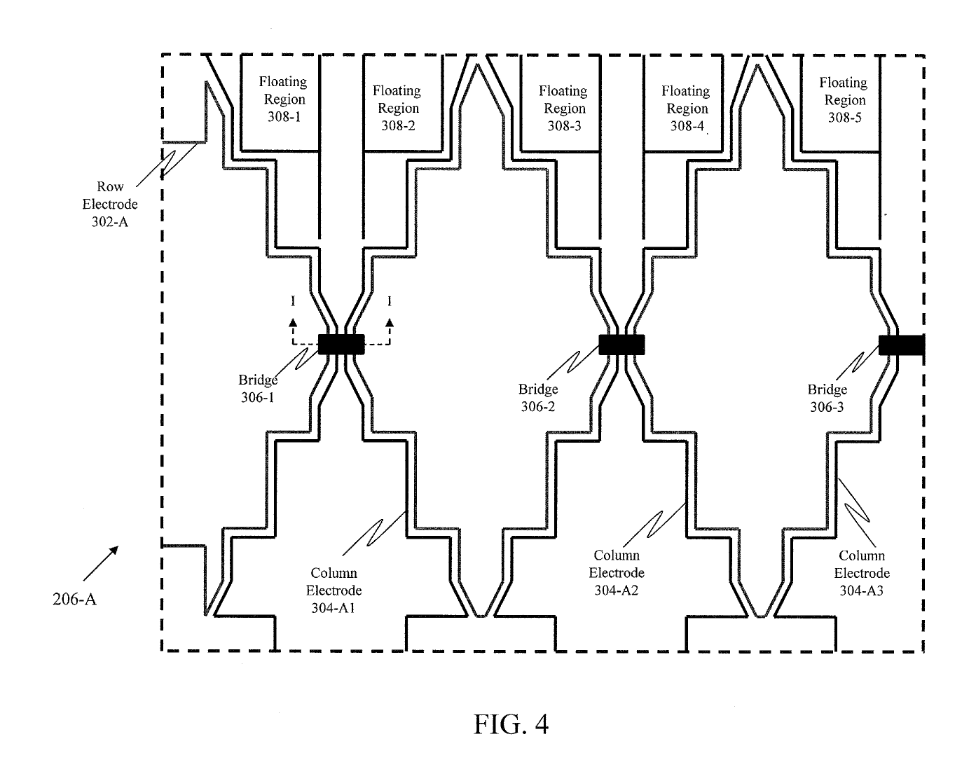

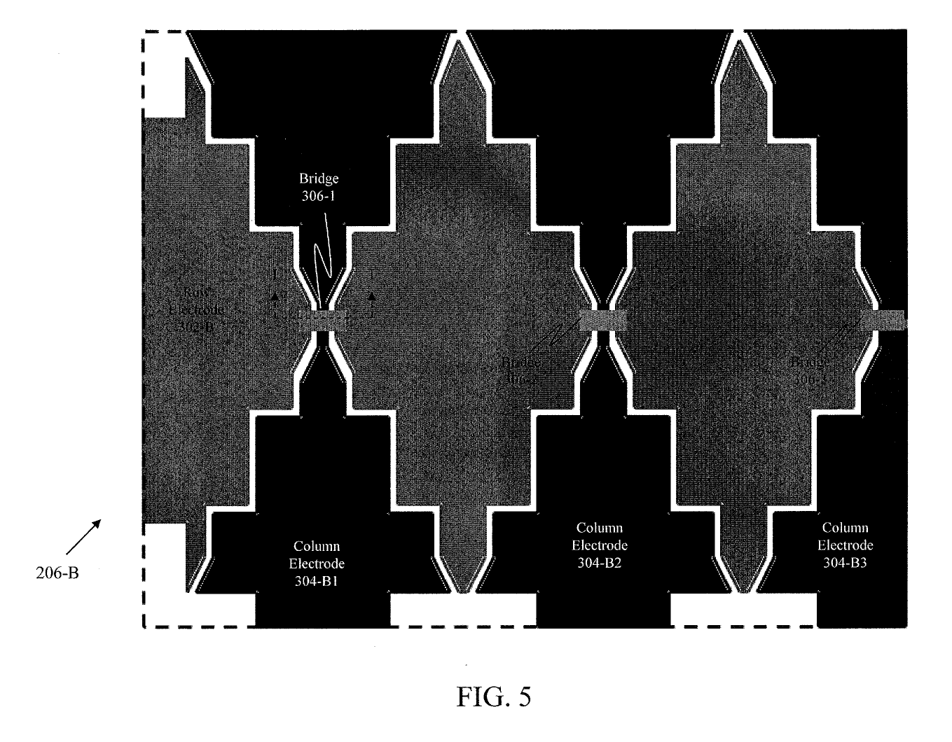

In FIG. 4, portion 206 of touch panel 202 can be seen in greater detail. Specifically, row electrode 302-A and column electrodes 304-A1 to 304-A3 can be seen. As shown in this example, column electrodes 304-A1 to 304-A3 can be formed of conductive traces, which can be formed of fine line conductors or formed of a material that is substantially transparent to visible spectrum light. Additionally, a conductive strip can be inserted in column direction within column electrodes to reduce the resistivity. These conductive traces outline a “stair-stepped diamond” pattern that differs from the diamond pattern shown in FIG. 1, where there are straight line boundaries. By including the stair-stepped diamond patterns, the interleaved row electrode 302-A and column electrodes 304-A1 to 304-A3 have increased perimeters, which can help increase mutual capacitance and sensitivity. However, because of the interleaved arrangement of row electrode 302-A and column electrodes 304-A1 to 304-A3, the stair-stepped diamonds of the row electrode 302-A are coupled together by bridges 306-1 to 306-3; alternatively, the bridges 306-1 to 306-3 can be used to couple stair-stepped diamonds of the column electrodes 304-A1 to 304-A3 together. As an example, the material used to form the bridges 306-1 to 306-3 can be a highly conductive, non-transparent material (e.g. copper) or a conductive, transparent material (indium tin oxide or ITO). Floating regions (e.g., floating regions 308-1 to 308-5) can optionally be included within the stair-stepped diamonds, which can improve optical characteristics and response of the touch panel (i.e., 202). These floating regions (e.g., floating regions 308-1 to 308-6) can also be formed of conductive traces, which can be formed of fine line conductors or formed of a material that is substantially transparent to visible spectrum light. Alternatively, as shown in the example of portion 206-B in FIG. 5, the stair-stepped diamonds of row electrodes 302-B and column electrodes 304-B1 to can be formed of a conductive pad that are formed of a material that is substantially transparent to visible spectrum light.

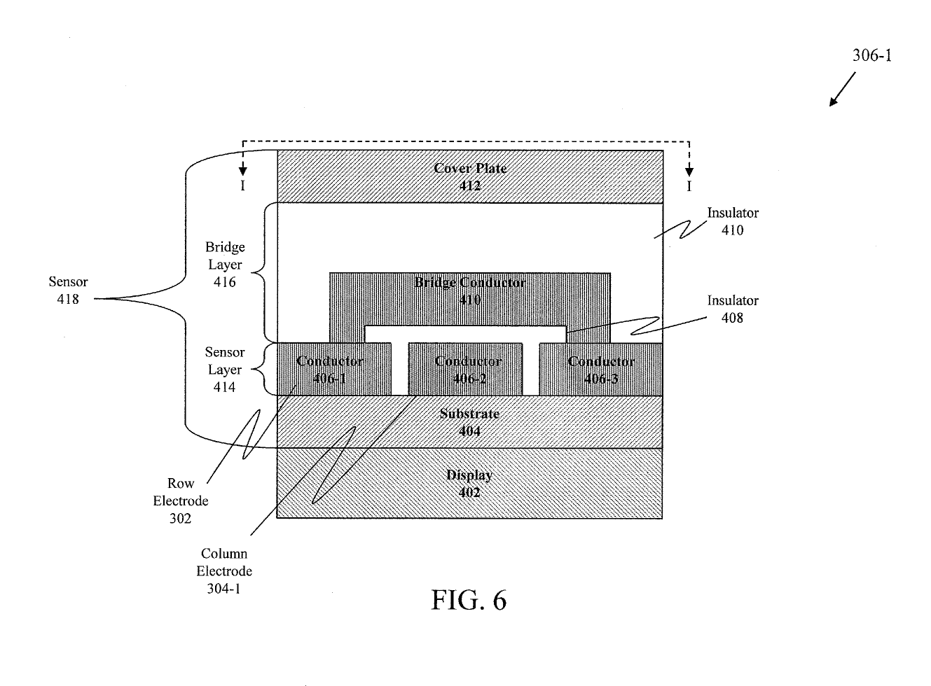

Turning to FIG. 6, a cross sectional view for the bridge 306-1 of section 206 of touch panel 202 can be seen. As shown in this example, the touch panel 202 is generally comprised of a touch sensor 418 disposed over or positioned over a display 402 (which can, for example be a liquid crystal display or LCD) so as to allow the light from the display to project through the sensor 418. This means that each layer of the sensor 322 is substantially transparent to visible spectrum light (e.g., wavelengths from about 390 nm to about 750 nm). As shown, the touch sensor 418 is a dual or two layer sensor, having a sensor layer 414, a bridge layer 416, and cover plate 412. As shown in this example, row electrode 302 includes conductors 406-1 and 406-3 that are coplanar with the conductors 406-2 of column electrode 304-1 that are formed over substrate 404. Typically, the substrate 404 is formed of glass (which is substantially transparent to visible spectrum light), and the conductors 406-1 to 406-3 are usually formed of a conductive material that is generally transparent to visible spectrum light (such as indium tin oxide, aluminum doped zinc oxide, gallium doped zinc oxide, or indium doped zinc oxide). Conductors 406-1 to 406-3 can formed by electron beam evaporation, physical vapor deposition (PVD), or sputter deposition on the substrates 302 and 308, which can, for example, then be patterned using laser ablation or etching. Alternatively, fine line conductors (which may or may not be transparent to visible spectrum light) can be printed onto substrate 404. An insulator 408 can then be provided to electrically isolate conductors 406-1 and 406-3, and a bridge conductor 410 (which can be a fine line conductor or formed of a material that is substantially transparent to visible light) be formed over insulator 408 so as to couple conductors 406-1 and 406-3 together. The remainder of the bridge layer can be formed of an insulator 410 (which can be an adhesive, like epoxy) that can be secured to cover plate 412 (which can also be glass). As an alternative, the conductors 406-1 to 406-3 can be formed on cover plate 412.

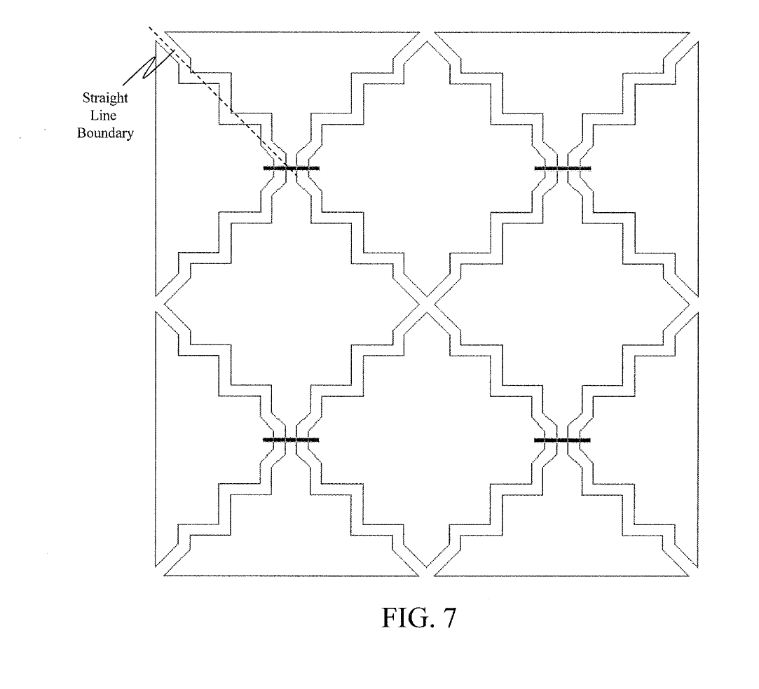

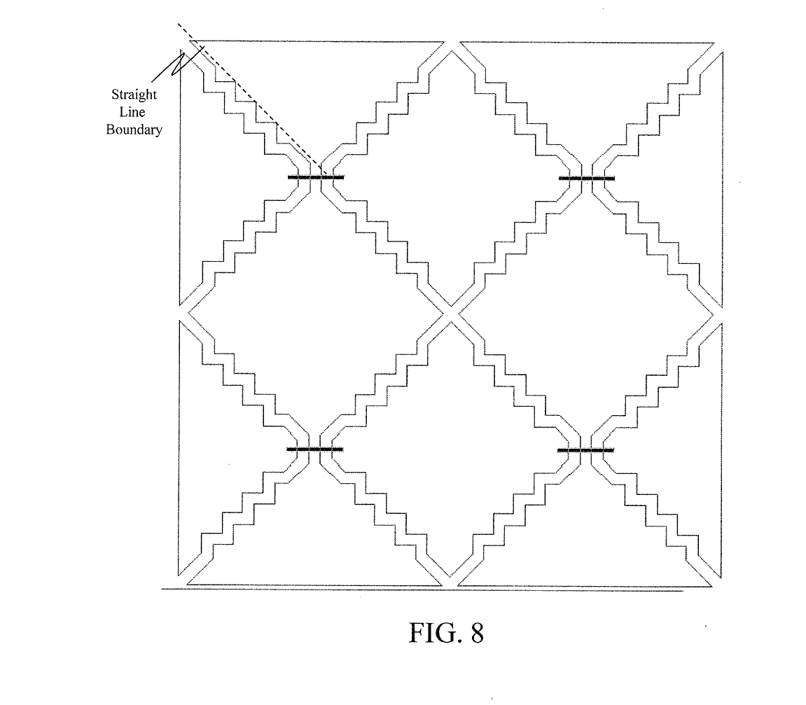

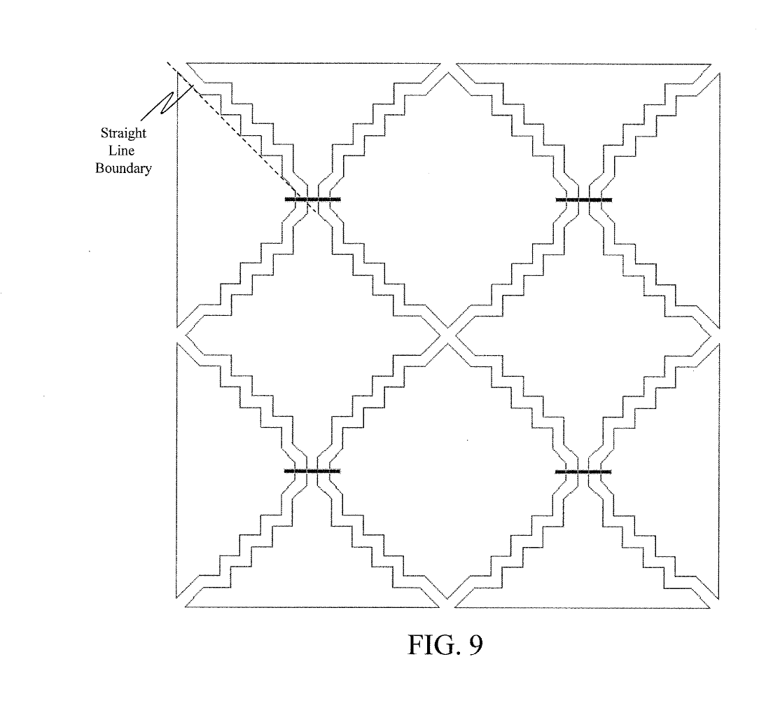

Alternatively, shapes of the stair-stepped diamond patterns can be varied in several ways, examples of which can be seen in FIGS. 7-9. In the example of FIG. 7, the staircase portion of the stair-stepped diamond patterns is formed on top of the straight line boundary. In the example of FIG. 8, the staircase portion of the stair-stepped diamond patterns is formed on top of the straight line boundary is shifted from the straight line boundary into row diamond electrode, and in the example of FIG. 9, the staircase portion of the stair-stepped diamond patterns is formed on top of the straight line boundary is shifted from the straight line boundary into column diamond electrode. Each of the example implementations can allow tailoring of sensor resistance between row and column electrodes. Additionally, another example (which can allow for an increase in mutual capacitance per intersection between a row electrode and column electrode under scan), two physical electrodes per logical column and one physical electrode per row, or a vice versa can be implemented. For this example, the mutual capacitance per row column intersection can be increased by 1.6 times.

As a result of using the configurations shown in FIGS. 3-9, several advantages can be realized. One advantage is that the touch panel 202 is more insensitive to its environment because of an increase mutual capacitance. Also, because the yield of bridges (e.g. 306-1) can be a major concern. There is motivation to reduce the overall bridge count, so, with this arrangement, the bridge count can be reduced, realizing another advantage.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Accordingly, it is appropriate that the appended claims be construed broadly and in a manner consistent with the scope of the invention.

1. An apparatus comprising:
a substrate;
a cover plate that is substantially transparent to visible spectrum light;
a sensor layer formed on at least one of the substrates and the cover plate, wherein the sensor layer includes:
a plurality of row electrodes;
a plurality of column electrodes interleaved with the plurality of row electrodes, wherein each row electrode and each column electrode is formed of a plurality of stair-stepped diamonds; and
an insulator that electrically isolates the plurality of row electrodes and the plurality of column electrodes, wherein the insulator is substantially transparent to visible spectrum light; and
a bridge layer formed over the sensor layer and having a plurality of bridges, wherein each bridge is coupled between two adjacent stair-stepped diamonds from at least one of the column electrodes or the row electrodes.

2. The apparatus of claim 1, wherein the conductive layer is formed on the cover plate.

3. The apparatus of claim 1, wherein the conductive layer is formed on the substrate.

4. The apparatus of claim 3, wherein the plurality of bridges further comprises a plurality of set of bridges, wherein each set of bridges is associated with at least one of the column electrodes.

5. The apparatus of claim 3, wherein the plurality of bridges further comprises a plurality of set of bridges, wherein each set of bridges is associated with at least one of the row electrodes.

6. The apparatus of claim 5, wherein each stair-stepped diamond is formed of a conductive trace.

7. The apparatus of claim 6, wherein each bridge and each conductive trace is substantially transparent to visible spectrum light.

8. The apparatus of claim 7, wherein the sensor layer further comprises a plurality of floating regions, wherein each floating region is substantially transparent to visible spectrum light, and wherein each floating region is located within at least one of the stair-stepped diamonds.

9. The apparatus of claim 3, wherein each bridge is substantially transparent to visible spectrum light, and wherein each stair-stepped diamond is formed of a conductive pad.

10. An apparatus comprising:
a touch panel having:
a substrate;
a cover plate that is substantially transparent to visible spectrum light;
a sensor layer formed on at least one of the substrates and the cover plate, wherein the sensor layer includes:
a plurality of row electrodes;
a plurality of column electrodes interleaved with the plurality of row electrodes, wherein each row electrode and each column electrode is formed of a plurality of stair-stepped diamonds; and
an insulator that electrically isolates the plurality of row electrodes and the plurality of column electrodes, wherein the insulator is substantially transparent to visible spectrum light; and
a bridge layer formed over the sensor layer and having a plurality of bridges, wherein each bridge is coupled between two adjacent stair-stepped diamonds from at least one of the column electrodes or the row electrodes;
an interconnect that is coupled to each row electrode and each column electrode; and
a touch panel controller that is coupled to the interconnect.

11. The apparatus of claim 10, wherein the conductive layer is formed on the cover plate.

12. The apparatus of claim 10, wherein the conductive layer is formed on the substrate.

13. The apparatus of claim 12, wherein the plurality of bridges further comprises a plurality of set of bridges, wherein each set of bridges is associated with at least one of the column electrodes.

14. The apparatus of claim 12, wherein the plurality of bridges further comprises a plurality of set of bridges, wherein each set of bridges is associated with at least one of the row electrodes.

15. The apparatus of claim 14, wherein each stair-stepped diamond is formed of a conductive trace.

16. The apparatus of claim 15, wherein each bridge and each conductive trace is substantially transparent to visible spectrum light.

17. The apparatus of claim 16, wherein the sensor layer further comprises a plurality of floating regions, wherein each floating region is substantially transparent to visible spectrum light, and wherein each floating region is located within at least one of the stair-stepped diamonds.

18. The apparatus of claim 12, wherein each bridge is substantially transparent to visible spectrum light, and wherein each stair-stepped diamond is formed of a conductive pad.

19. An apparatus comprising:
a touch panel having:
a display;
a substrate that is secured to the display, wherein the substrate is substantially transparent to visible spectrum light;
a sensor layer formed over the substrate, wherein the sensor layer includes:
a plurality of row electrodes formed over the substrate, wherein each row electrode is formed of a first set of stair-stepped diamonds;
a plurality of column electrodes formed over the substrate, wherein each column electrode is formed of a second set of stair-stepped diamonds that are coupled together; and
an first insulator that is formed over the substrate, wherein the first insulator is substantially transparent to visible spectrum light, and wherein the first insulator electrically isolates the plurality of row electrodes and the plurality of column electrodes;
a bridge layer formed over the sensor layer, wherein the bridge layer includes:
a plurality of sets of bridge conductors, wherein each set of bridge conductors is associated with at least one of the row electrodes so as to couple each stair-stepped diamond in each row electrode together; and
a second insulator formed over the sensor layer, wherein the second insulator is substantially transparent to visible spectrum light;
a cover plate that is secured to the bridge layer, wherein the cover plate is substantially transparent to visible spectrum light;
an interconnect that is coupled to each column electrode and each row electrode; and
a touch panel controller having:
an interface that is coupled to the interconnect; and
a control circuit that is coupled to the interface.

20. The apparatus of claim 19, wherein each stair-stepped diamond is formed of a conductive trace.

21. The apparatus of claim 20, wherein the sensor layer further comprises a plurality of floating regions, wherein each floating region is located within at least one of the stair-stepped diamonds.

22. The apparatus of claim 19, wherein each stair-stepped diamond is formed of a conductive pad that is substantially transparent to visible spectrum light.

23. The apparatus of claim 22, wherein the plurality of row electrodes, the plurality of column electrodes, and the plurality of bridge conductors are formed of indium tin oxide (ITO).
